(19) United States
(12) Patent Application Publication
(10) Pub. No.: US 2019/0340652 A1
(43) Pub. Date: Nov. 7, 2019

(54) INFORMATION PROCESSING DEVICE AND PROGRAM

(71) Applicant: FreakOut Holdings, inc, Minato-ku, Tokyo (JP)

(72) Inventor: Yuzuru HONDA, Tokyo (JP)

(21) Appl. No.: 16/316,308

(22) PCT Filed: Jul. 11, 2017
(86) PCT No.: PCT/JP2017/025302

§ 371 Date: Jan. 8, 2019

(30) Foreign Application Priority Data
Jul. 11, 2016 (JP) 2016-147827

(51) Int. Cl. G06Q 30/02

(52) U.S. Cl. CPC G06Q 30/0266; G06Q 30/0261; G06Q 30/0255; G06Q 30/0269

(57) ABSTRACT

The present invention addresses the problem of providing an information processing device and a program with which it is possible to selectively deliver an advertisement so as to suit each individual user. An information processing device 30 delivers an advertisement to an onboard terminal 20 provided in a mobile body 100, the information processing device 30 being provided with: a place information acquisition unit 32 for acquiring information pertaining to a place at which a user aboard the mobile body 100 stops, as place information; and an advertisement delivery unit 36 for acquiring advertisement information on the basis of the acquired place information and delivering advertisement information to the onboard terminal 20.

### TECHNICAL FIELD

The present invention relates to an information processing device and program.

### BACKGROUND ART

Since heretofore, advertisements are displayed at on-board terminals disposed in mobile bodies. For example, Patent Document 1 recites a technology that presents advertisements on a display of an on-board terminal and seeks to further improve advertising effectiveness for vehicle occupants.

### Patent Document 1: Japanese Unexamined Patent Application, Publication No. 2000-200077

### DISCLOSURE OF THE INVENTION

### Problems to be Solved by the Invention

A system recited in Patent Document 1 is equipped with a video package, a display device, and a leaflet. The leaflet is printed matter with text, photographs, graphics and the like relating to program content of the video package. When a user (vehicle occupant) is riding in the mobile body, the system starts to display video images of the video package.

However, this system shows advertisements with arbitrary fixed content. Moreover, the advertising content of the video images being displayed can only be selected by selection of the video package, a teletext system or the like. It is difficult to inspire users to watch the advertisements willingly. No techniques are given for matching the tastes of users; the fact is that advertisements are not being deployed effectively. Accordingly, it would be useful if advertisements can be delivered selectively to suit individual users.

An object of the present invention is to provide an image processing device and program that may selectively deliver advertisements to suit individual users.

### Means for Solving the Problems

The present invention relates to an image processing device that delivers advertisement information to an on-board terminal employed in a mobile body, the information processing device including: a place information acquisition unit that acquires, as place information, information pertaining to a place that a user aboard the mobile body is approaching; and an advertisement delivery unit that acquires advertisement information on the basis of the acquired place information, and delivers the acquired advertisement information to the on-board terminal.

It is preferable if the image processing device further includes an area specification unit that specifies an area containing the place represented by the place information acquired by the place information acquisition unit, wherein the advertisement delivery unit acquires advertisement information relating to the specified area.

It is preferable if the place information acquisition unit includes: a terminal association unit that associates a user terminal carried by the user aboard the mobile body with the on-board terminal; and a place information specification unit that specifies the place information on the basis of information pertaining to the user terminal associated with the on-board terminal, wherein the advertisement delivery unit delivers the advertisement information to the on-board terminal associated with the user terminal.

It is preferable if the terminal association unit acquires on-board terminal identification information from the on-board terminal, acquires place information and user terminal identification information from the user terminal, and associates the on-board terminal with the user terminal, and the place information specification unit specifies the acquired position information as place information.

It is preferable if the terminal association unit associates the user terminal with the on-board terminal on the basis of information acquired from the user terminal by communications between the user terminal and the on-board terminal.

It is preferable if the terminal association unit associates the user terminal with the on-board terminal on the basis of user terminal identification information that identifies the user terminal, the user terminal identification information being obtained by a payment process between the on-board terminal and the user terminal.

It is preferable if the terminal association unit acquires position information of the on-board terminal and position information of plural arbitrary user terminals, and associates the on-board terminal with a user terminal that is moving in correspondence with positions of the on-board terminal.

It is preferable if, if no user terminal is available to be associated with the on-board terminal, the terminal association unit does not perform the association of the user terminal with the on-board terminal.

It is preferable if the place information specification unit acquires place information from the user terminal, and specifies the acquired place information as the place information.

It is preferable if the place information specification unit acquires inference information from which place information may be inferred from the user terminal, and specifies the place information on the basis of the inference information.

It is preferable if the place information specification unit acquires user terminal identification information that identifies the user terminal from the user terminal, and specifies the place information on the basis of the acquired user terminal identification information and a previous ride history of the user.

It is preferable if the place information specification unit specifies the place information on the basis of the user terminal identification information and a previous ride history of the user, the user terminal identification information identifying a user terminal that is moving in correspondence with positions of the on-board terminal.

It is preferable if the place information specification unit specifies the place information on the basis of voice information transmitted from the on-board terminal that includes a voice message by the user, a driver or another occupant aboard the mobile body.

The present invention further relates to a program executable by a computer including a processor, which program causes the computer to realize the functions of an information processing device that delivers advertisement information to an on-board terminal employed in a mobile body, the program causing the computer to function as: a place information acquisition unit that acquires, as place information, information pertaining to a place that a user aboard the mobile body is approaching; and an advertisement delivery unit that acquires advertisement information on the basis of the acquired place information, and delivers the acquired advertisement information to the on-board terminal.

### Effects of the Invention

According to the present invention, an image processing device and program that may selectively distribute advertisements so as to suit individual users may be provided.

### BRIEF DESCRIPTION OF THE DRAWINGS

FIG. 1 is a schematic diagram of an information processing system including an information processing device according to an embodiment of the present invention.

FIG. 2 is a block diagram of the information processing device according to the embodiment.

FIG. 3 depicts historical information memorized in a historical information database of the information processing device according to the embodiment.

FIG. 4 is a block diagram of a place information acquisition unit of the information processing device according to the embodiment.

FIG. 5 is a flowchart depicting a processing flow of advertisement delivery utilizing the information processing device according to the embodiment.

FIG. 6 is a flowchart depicting a processing flow of place information specification processing according to the embodiment.

### PREFERRED MODE FOR CARRYING OUT THE INVENTION

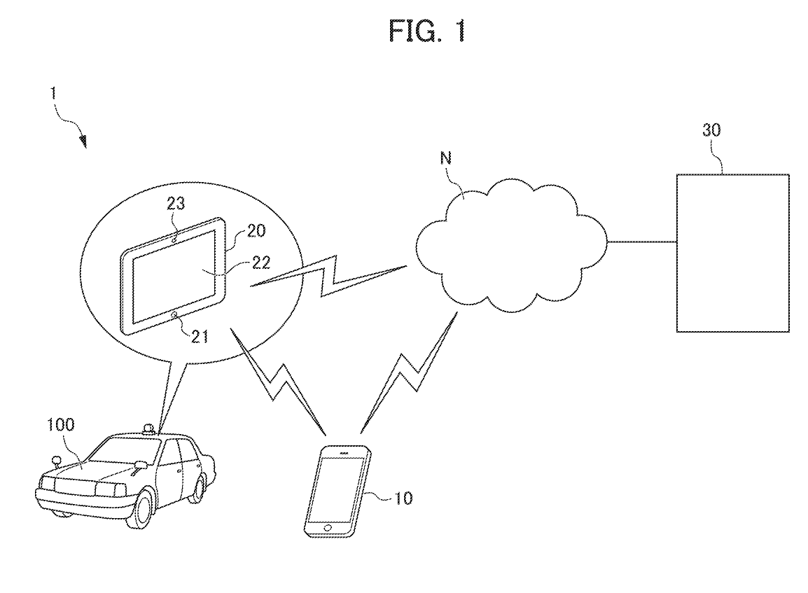

Below, an information processing device and program according to an embodiment of the present invention are described with reference to the drawings. First, an information processing system 1 in which the information processing device according to the present embodiment is utilized is described with reference to FIG. 1.

As illustrated in FIG. 1, the information processing system 1 is a system for displaying an advertisement to a user (for example, a taxi passenger) at an on-board terminal 20 disposed in a mobile body 100 (for example, the taxi). The advertisement is displayed on the basis of a place at which the user will stop, such as a transfer point, a destination or the like. The information processing system 1 is provided with a user terminal 10, the on-board terminal 20, and an information processing device 30.

The user terminal 10 is, for example, a portable terminal such as a smartphone or the like carried by the user. The user terminal 10 is capable of communications with the on-board terminal 20. The user terminal 10 is also capable of executing an application that is used for dispatching the mobile body 100 (below referred to as a “dispatch app”). When the dispatch app has been installed in the user terminal 10, the user terminal 10 is capable of transmitting at least user terminal identification information that identifies the user terminal 10 to the on-board terminal 20, which is described below. This user terminal identification information is information for identifying the corresponding user terminal 10. For example, the user terminal identification information is expressed by unique information such as a manufacturer's serial number of the user terminal 10, a MAC address assigned to the user terminal 10, or the like.

The user terminal 10 enables transmission of the user terminal identification information to the on-board terminal 20 when processing a payment using a two-dimensional barcode (for example, a QR code (registered trademark)), which is described below. The user terminal 10 also enables transmission of the user terminal identification information to the on-board terminal 20 when specified to enable communications (communications conforming to BLUETOOTH (registered trademark), detection of beacons conforming to BLUETOOTH, near field communications (NFC) conforming to a standard such as, for example, Felica (registered trademark) or the like, and the like).

The on-board terminal 20 is an on-board terminal employed in the mobile body 100, which is realized as, for example, a tablet-type terminal. The on-board terminal 20 is provided with a voice acquisition unit 21 (for example, a microphone) that is capable of acquiring the voice of a driver or other vehicle occupant to be used as voice message information, a display unit 22 (for example, a display) that is capable of displaying advertisements,

and an imaging unit 23 (for example, a camera) that is capable of acquiring images of users to be used as image information. The on-board terminal 20 is disposed in a position at which a user riding in the mobile body 100 may view an advertisement being displayed on the display unit 22.

The above-described on-board terminal 20 is capable of communicating with the user terminal 10 carried by a user aboard the mobile body 100. The on-board terminal 20 can communicate with the user terminal 10 by, for example communications conforming to BLUETOOTH, beacon detection conforming to BLUETOOTH, and the like. The on-board terminal 20 is capable of transmitting information obtained by communications with the user terminal 10 (for example, the aforementioned user terminal identification information and the like) to the information processing device 30, which is described below. The on-board terminal 20 can also transmit on-board terminal identification information that identifies the on-board terminal 20 to the information processing device 30 that is described below. The on-board terminal identification information is information for identifying the corresponding on-board terminal 20. Similarly to the user terminal identification information, the on-board terminal identification information is expressed by unique information such as, for example, a manufacturer's serial number of the on-board terminal 20, a MAC address assigned to the on-board terminal 20, or the like.

The information processing device 30 is, for example, a cloud-based server and is capable of communicating with the on-board terminal 20 via a network N. The information processing device 30 is capable of delivering, for example, advertisements (advertisement information) to the on-board terminal 20 provided in the mobile body 100.

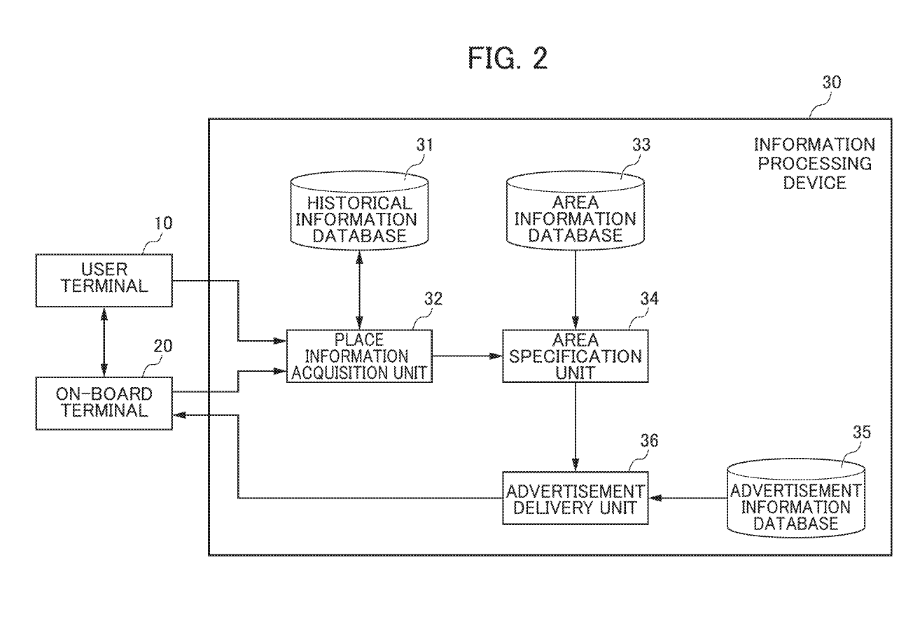

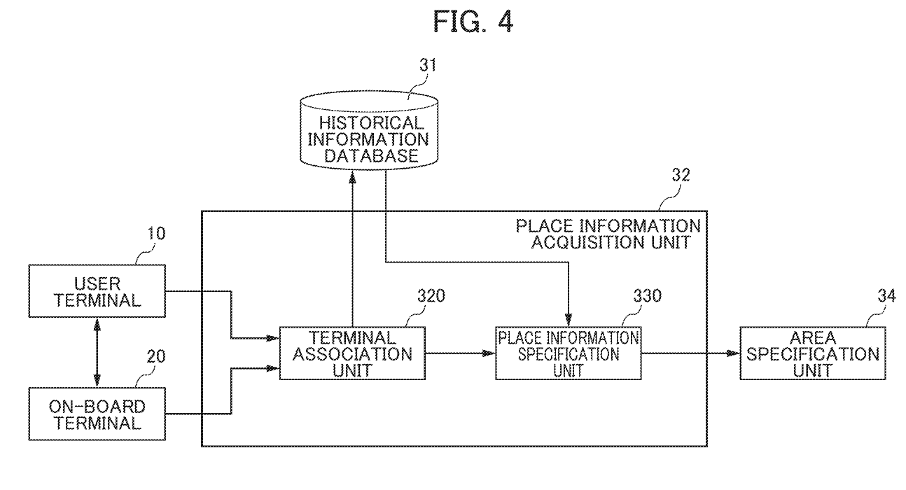

Now, configuration of the information processing device 30 is described with reference to FIG. 2 and FIG. 4. As illustrated in FIG. 2, the information processing device 30 is provided with a historical information database 31, a place information acquisition unit 32, an area information database 33, an area specification unit 34, an advertisement information database 35, and an advertisement delivery unit 36.

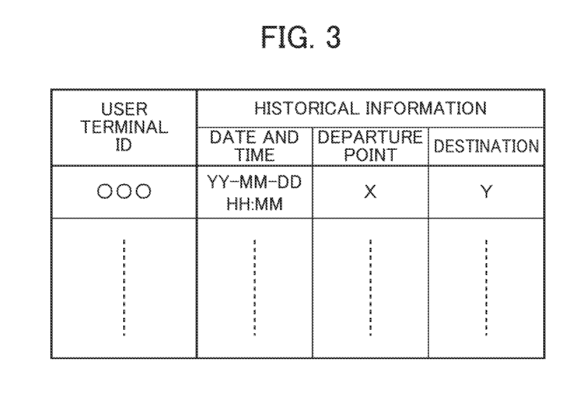

The historical information database 31 stores a ride history of previous rides by users in the mobile body 100. More specifically, as illustrated in FIG. 3, the historical information database 31 stores user identification information identifying user terminals 10 and the history of previous rides in the mobile body 100 as historical information. The historical information database 31 stores dates, times, departure points, destinations and the like as the ride history of previous rides by users. The historical information database 31 may acquire and store a ride history of previous rides by a user from an external server (for example, a server of an enterprise administering the mobile body 100, which is not shown in the drawings). Further, the historical information database 31 may acquire and store a usage history of the dispatch app installed in the user terminal 10 to be used as historical information.

The place information acquisition unit 32 acquires information pertaining to a place that the user riding in the mobile body 100 is approaching (a transfer point or destination) to be used as place information. The place information acquisition unit 32 also makes an association between the on-board terminal 20 and the user terminal 10. As illustrated in FIG. 4, the place information acquisition unit 32 is provided with a terminal association unit 320 and a place information specification unit 330.

The terminal association unit 320 associates the user riding in the mobile body 100 with the on-board terminal 20 employed in the mobile body 100 that the user is riding. That is, the terminal association unit 320 associates the user terminal 10 that is carried by the user aboard the mobile body 100 with the on-board terminal 20 that is employed in the mobile body 100. More specifically, the terminal association unit 320 associates the user terminal 10 with the on-board terminal 20 on the basis of information acquired from the terminals by communications between the user terminal 10 and the on-board terminal 20.

For example, the terminal association unit 320 acquires the on-board terminal identification information identifying the on-board terminal 20 and the user terminal identification information identifying the user terminal 10 from the on-board terminal 20 and associates the same. The terminal association unit 320 acquires and associates the on-board terminal identification information and the user terminal identification information from the on-board terminal 20: when the user terminal employs the dispatch app; when a two-dimensional barcode (QR code (registered trademark)), which is described below, is used to process a payment; when a communications setting is enabled; or the like.

If the on-board terminal 20 cannot communicate with the user terminal 10 due to a communications setting being disabled at the user terminal 10, the terminal association unit 320 acquires position information of the on-board terminal and position information of arbitrary plural user terminals, and associates the on-board terminal 20 with a user terminal 10 that is moving in correspondence with the position of the on-board terminal 20. If the position information of the plural user terminals 10 is collected by a server (not shown in the drawings) of an enterprise providing another application (for example, a map guidance application) or the like, the position information of the user terminals 10 may be acquired from the server of that enterprise subject to permission having been granted by the users.

If the on-board terminal 20 cannot communicate with the user terminal 10 due to the power of the user terminal 10 being turned off, no user terminal 10 actually being carried or the like, the terminal association unit 320 does not make the association of a user terminal with the on-board terminal 20. The association made by the terminal association unit 320 is described in more detail below.

The place information specification unit 330 specifies place information on the basis of the user terminal identification information acquired from the associated user terminal 10. The specification performed by the place information specification unit 330 is described in more detail below.

The area information database 33 stores area information representing areas containing transfer points, destinations and the like included in place information. For example, the area information database 33 stores area information representing large areas containing transfer points, destinations and the like that are represented by place information.

The area specification unit 34 specifies an area containing the place information acquired by the place information acquisition unit 32. More specifically, the area specification unit 34 accesses the area information database 33 and specifies, from the area information, an area containing a transfer point, destination or the like represented by the place information.

The advertisement information database 35 stores advertisement information to be delivered to the on-board terminal 20 as advertisement information. The advertisement information database 35 stores advertisement files associated with areas to be used as the advertisement information.

The advertisement delivery unit 36 acquires the advertisement information associated with the area specified by the area specification unit 34 and delivers the acquired advertisement information to the on-board terminal 20 identified by the on-board terminal identification information. More specifically, the advertisement delivery unit 36 accesses the advertisement information database 35 and acquires an advertisement file associated with the area specified by the area specification unit 34 as the advertisement information. The advertisement delivery unit 36 delivers the acquired advertisement information to the on-board terminal 20 identified by the on-board terminal identification information. When place information cannot be acquired by the place information acquisition unit 32, the advertisement delivery unit 36 acquires arbitrary advertisement information from the advertisement information database 35 and delivers this acquired advertisement information to the on-board terminal 20 identified by the on-board terminal identification information.

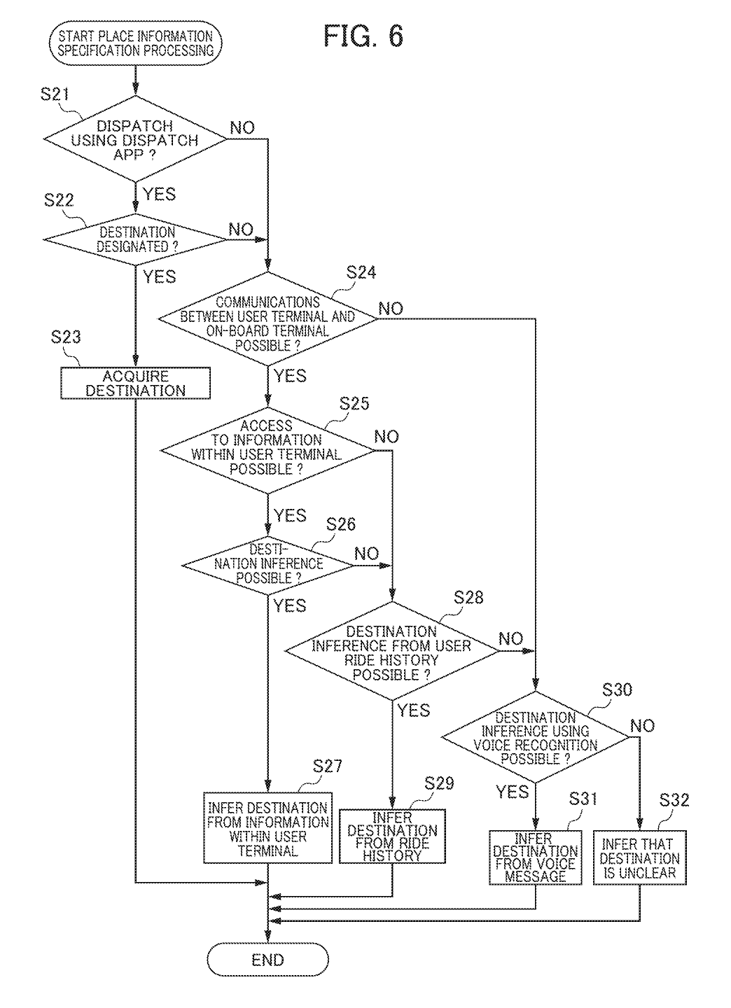

Now, the terminal association unit 320 and place information specification unit 330 are described in more detail. Depending on information about the user terminal 10 that can be acquired from the on-board terminal 20, the terminal association unit 320 and place information specification unit 330 make a determination as to which of the following states (state 1 to state 4) applies. Then, the terminal association unit 320 and place information specification unit 330 make the association by a method corresponding to the respective state. Which state is determined in different situations is described below with reference to FIG. 6.

### —State 1—

State 1 is a situation in which a transfer point or destination indicating place information is designated when the mobile body 100 is dispatched by use of the dispatch app at the user terminal 10. That is, state 1 is a situation in which the user terminal identification information and place information are obtained by the on-board terminal 20 communicating with the user terminal 10. In this situation, the terminal association unit 320 acquires the on-board terminal identification information, the user terminal identification information and the place information from the on-board terminal 20 and associates the on-board terminal identification information with the user terminal identification information. The place information specification unit 330 simply specifies the place acquired by the terminal association unit 320 as the place information.

### —State 2—

State 2 is a situation in which no transfer point or destination indicating place information is designated when the mobile body 100 is dispatched by use of the dispatch app at the user terminal 10, but the terminal association unit 320 can obtain inference information with which to infer place information from within the user terminal 10. That is, a situation in which the on-board terminal 20 can communicate with the user terminal 10 by a payment process, BLUETOOTH, beacons, or NEC but place information is not directly obtained is regarded as state 2. A situation in which the mobile body 100 is not dispatched by use of the dispatch app at the user terminal 10 (for example, a situation in which the mobile body 100 is hailed by a raised hand) but the terminal association unit 320 can obtain inference information with which place information can be inferred from within the user terminal 10 is also regarded as state 2.

In this state, the terminal association unit 320 acquires the on-board terminal identification information and the user terminal identification information from the on-board terminal 20, and associates the on-board terminal identification information with the user terminal identification information. The terminal association unit 320 also acquires the inference information via the on-board terminal 20.

The place information specification unit 330 specifies place information on the basis of the inference information. For example, the place information specification unit 330 acquires calendar information as the inference information and specifies a transfer point or destination included in a plan at the date and time of the dispatch as the place information. As alternative examples, the place information specification unit 330 uses a log of GPS positions at the time of day of the dispatch, webpages that have been displayed, a search history of transfer points and destinations, or the like as the inference information and specifies the place information from this inference information.

### —State 3—

State 3 is a situation in which the mobile body 100 is not dispatched by use of the dispatch app at the user terminal 10 (for example, a situation in which the mobile body 100 is hailed by a raised hand) but the terminal association unit 320 can acquire the user terminal identification information from the on-board terminal 20. In this state, the terminal association unit 320 acquires the on-board terminal identification information and the user terminal identification information from the on-board terminal 20, and associates the on-board terminal identification information with the user terminal identification information.

The place information specification unit 330 specifies the place information from a previous ride history related with the user terminal identification information of the user terminal 10 that is associated with the on-board terminal 20. More specifically, the place information specification unit 330 reads a transfer point or destination contained in the history information associated with the user terminal identification information from the historical information database 31, and specifies that transfer point or destination as the place information.

### —State 4—

State 4 is a situation in which the mobile body 100 is not dispatched by use of the dispatch app at the user terminal 10 (for example, a situation in which the mobile body 100 is hailed by a raised hand) and the terminal association unit 320 cannot acquire user terminal identification information from the on-board terminal 20. In this situation, the terminal association unit 320 acquires the on-board terminal identification information and voice information from the on-board terminal 20. Further, a situation in which the on-board terminal 20 cannot communicate with the user terminal 10 but a user terminal 10 that is moving in correspondence with positions of the mobile body 100 can be identified is regarded as state 4. In this situation, the terminal association unit 320 acquires position information of the mobile body 100 and position information of arbitrary plural user terminals, and specifies a user terminal 10 that is moving in correspondence with positions of the mobile body 100. The terminal association unit 320 associates the user terminal identification information of the specified user terminal 10 with the on-board terminal identification information of the mobile body 100.

The place information specification unit 330 analyzes the voice information and specifies the place information. For example, in the voice information, the place information specification unit 330 analyzes a voice message directly after boarding, when there is a high probability of the voice message indicating a transfer point or destination, and specifies the place information.

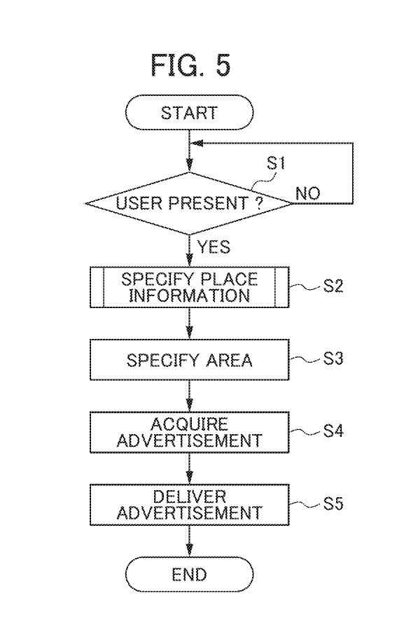

Now, processing flows of the information processing device 30 according to the present embodiment are described with reference to FIG. 5 and FIG. 6.

First, in step S1, the place information acquisition unit 32 makes a determination as to whether or not a user is present in the mobile body 100. More specifically, the place information acquisition unit 32 makes a determination as to whether on-board terminal identification information has been transmitted from the on-board terminal 20. If the place information acquisition unit 32 has acquired the on-board terminal identification information from the on-board terminal 20, the information processing device 30 proceeds to step S2 On the other hand, if the place information acquisition unit 32 has not acquired the on-board terminal identification information from the on-board terminal 20, the information processing device 30 returns to step S1.

In step S2, the place information acquisition unit 32 specifies place information on the basis of information received from the on-board terminal 20. Place information specification processing for specifying the place information is described in detail below. After the place information acquisition unit 32 specifies the place information, the information processing device 30 proceeds to step S3.

In step S3, the area specification unit 34 specifies an area containing a transfer point, destination or the like represented by the place information. The area specification unit 34 sends the specified area to the advertisement delivery unit 36, and the information processing device 30 proceeds to step S4.

In step S4, the advertisement delivery unit 36 acquires advertisement information on the basis of the area information, and the information processing device 30 proceeds to step S5. In step S5, the advertisement delivery unit 36 delivers the acquired advertisement information to the on-board terminal 20. Thus, operations at the information processing device 30 are complete.

Now, the place information specification processing in step S2 is described with reference to FIG. 6. First, in step S21, the terminal association unit 320 makes a determination as to whether the dispatch app has been used for the dispatch. If the dispatch app has been used for the dispatch, the place information acquisition unit 32 proceeds to step S22. On the other hand, if the dispatch app has not been used for the dispatch, the place information acquisition unit 32 proceeds to step S24.

In step S22, if the dispatch app has been used for the dispatch and a transfer point, destination or the like (place information) is designated (a state 1 situation), the terminal association unit 320 acquires the on-board terminal identification information, user terminal identification information and place information. The terminal association unit 320 associates the acquired on-board terminal identification information and user terminal identification information. The terminal association unit 320 sends the acquired information to the place information specification unit 330, and the place information acquisition unit 32 proceeds to step S23. On the other hand, if the dispatch app has been used for the dispatch but no transfer point or destination (place information) is designated (a state 2 situation), the place information acquisition unit 32 proceeds to step S24.

In step S23, the place information specification unit 330 simply specifies the transfer point or destination included in the place information sent from the terminal association unit 320 as the place information. The place information specification unit 330 sends the on-board terminal identification information, user terminal identification information and place information to the area specification unit 34, completing the place information specification processing.

In step S24, the terminal association unit 320 makes a determination as to whether communication with the user terminal 10 is possible. That is, the terminal association unit 320 makes a determination as to whether or not the situation is in state 2 or state 3. If the situation is in state 4, the terminal association unit 320 makes a determination as to whether identification of the user terminal 10 is possible. If state 2 or state 3 applies, or state 4 applies and identification of the user terminal 10 is possible, the terminal association unit 320 associates the on-board terminal identification information with the user terminal identification information, and the place information acquisition unit 32 proceeds to step S25. Otherwise (that is, if state 4 applies and the user terminal 10 cannot be identified), the terminal association unit 320 sends the on-board terminal identification information and voice information to the place information specification unit 330, and the place information acquisition unit 32 proceeds to step S30.

In step S25, the terminal association unit 320 makes a determination as to whether information within the user terminal 10 can be accessed. If the terminal association unit 320 can access information within the user terminal 10 (a state 2 situation), the terminal association unit 320 accesses the user terminal 10 and acquires inference information. The terminal association unit 320 also acquires the on-board terminal identification information and user terminal identification information from the on-board terminal 20, and sends the on-board terminal identification information, user terminal identification information and inference information to the place information specification unit 330. The place information acquisition unit 32 then proceeds to step S26. On the other hand, if the terminal association unit 320 cannot access information within the user terminal 10 (state 3 or a state 4 situation in which the user terminal 10 cannot be identified), the terminal association unit 320 acquires the on-board terminal identification information and user terminal identification information from the on-board terminal 20 and sends the same to the place information specification unit 330. The place information acquisition unit 32 then proceeds to step S28.

In step S26, the place information specification unit 330 makes a determination as to whether place information can be specified from the inference information. If the place information specification unit 330 can acquire place information from the inference information, the place information acquisition unit 32 proceeds to step S27. On the other hand, if the place information specification unit 330 cannot acquire place information from the inference information, the place information acquisition unit 32 proceeds to step S28.

In step S27, the place information specification unit 330 specifies place information from the inference information. Thus, the place information specification processing is complete.

In step S28, the place information specification unit 330 uses the user terminal identification information to access the previous ride history of the user. If the place information specification unit 330 can specify place information on the basis of the previous ride history of the user, the place information acquisition unit 32 proceeds to step S29. On the other hand, if the place information specification unit 330 cannot specify place information on the basis of the previous ride history of the user, the place information acquisition unit 32 proceeds to step S30.

In step S29, the place information specification unit 330 specifies the place information from the previous ride history of the user. Thus, the place information specification processing is complete.

In step S30, in a state 3 situation in which place information cannot be specified or a state 4 situation, the terminal association unit 320 associates the on-board terminal identification information with the voice information and sends the same to the place information specification unit 330. The place information specification unit 330 makes a determination as to whether the voice information can be analyzed and place information acquired. If the place information specification unit 330 can analyze the voice information and acquire place information, the place information acquisition unit 32 proceeds to step S31. On the other hand, if the place information specification unit 330 cannot analyze the voice information and acquire place information, the place information acquisition unit 32 proceeds to step S32.

In step S31, the place information specification unit 330 specifies the place information by analyzing the voice information. Thus, the place information specification processing is complete.

In step S32, the place information specification unit 330 specifies that there is no place information. Thus, the place information specification processing is complete.

Some or all of an information processing device encompassed by the present invention may be realized by hardware, software, or a combination of both. The meaning of the term “realized by software” is intended to include a computer loading and executing a program. In a case of a hardware structure, some or all of a server may be structured by an integrated circuit such as, for example, a large-scale integrated circuit (LSI), an application-specific integrated circuit (ASIC), a gate array, a field programmable gate array (FPGA) or the like.

If some or all of the functions provided in the information processing device encompassed by the present invention are constituted as software, a computer—structured with a bus connecting a memory unit such as a hard disk, ROM or the like in which a program defining some or all of the operations of the information processing device encompassed by the present invention is memorized, DRAM that memorizes data required for computations, a CPU and other sections—may realize the functions by memorizing information required for computations in the DRAM and executing the program at the CPU.

The program may be stored using any of various kinds of non-transitory computer readable medium and provided to the computer. Non-transitory computer readable media include various kinds of tangible storage medium. Examples of non-transitory computer readable media include magnetic recording media (for example, a flexible disc, magnetic disc or hard disc drive), magneto-optical recording media (for example, a magneto-optical disc), CD-ROMs (compact disc read-only memory), CD-Rs, CD-R/Ws, and semiconductor memories (for example, mask ROM, programmable ROM (PROM), erasable PROM (EPROM), Flash ROM or RAM (random access memory)).

According to the information processing device 30 and program described above, the following effects are provided.

(1) The information processing device 30 includes the place information acquisition unit 32 that acquires, as place information, information pertaining to a place that a user aboard the mobile body 100 is approaching, and the advertisement delivery unit 36 that acquires advertisement information on the basis of the acquired place information and delivers the advertisement information to the on-board terminal 20. Therefore, advertisements may be selectively delivered to suit individual users. Thus, advertisements that are more attractive to users may be provided.

(2) The information processing device 30 further includes the area specification unit 34 that specifies an area containing the place represented by the acquired place information, and the advertisement delivery unit 36 acquires advertisement information relating to the specified area. Therefore, even if there is no advertisement corresponding to the position represented by the place information, an advertisement pertaining to the local area may be displayed, and advertising effectiveness may be expected.

(3) The place information acquisition unit 32 includes the terminal association unit 320 that associates the user terminal 10 carried by a user riding in the mobile body 100 with the on-board terminal 20, and the place information specification unit 330 that specifies the place information on the basis of user terminal identification information obtained from the associated user terminal 10. The advertisement delivery unit 36 delivers the advertisement information to the on-board terminal 20 associated with the user terminal 10. Therefore, advertisements that are appropriate for each user may be delivered and an increase in advertising effectiveness may be expected.

(4) The terminal association unit 320 associates the user terminal 10 with the on-board terminal 20 on the basis of information acquired from the user terminal 10 by communications between the user terminal 10 and the on-board terminal 20. Therefore, the advertisement may be delivered to the appropriate on-board terminal 20.

(5) The terminal association unit 320 associates the user terminal 10 with the on-board terminal 20 on the basis of user terminal identification information identifying the user terminal 10 that is obtained by a payment process between the on-board terminal 20 and the user terminal 10. Therefore, the on-board terminal 20 may obtain information identifying the user terminal 10 easily, and the association between the on-board terminal 20 and the user terminal 10 may be made easily.

(6) The terminal association unit 320 acquires position information of the on-board terminal 20 and position information of arbitrary plural user terminals, and associates the on-board terminal 20 with a user terminal 10 that is moving in correspondence with positions of the on-board terminal 20. Therefore, even if user terminal identification information cannot be obtained from the user terminal 10, the on-board terminal 20 and the user terminal 10 may be associated and an appropriate advertisement may be delivered. Consequently, an increase in advertising effectiveness may be expected.

(7) If no user terminal can be associated with the on-board terminal 20, the terminal association unit 320 does not perform the association of a user terminal with the on-board terminal 20. Therefore, erroneous associations of user terminals with on-board terminals may be suppressed and delivery of inappropriate advertisements may be suppressed.

(8) The place information specification unit 330 acquires place information from the user terminal 10 and specifies this place information as the place information. Therefore, the place information may be specified easily and, because appropriate place information may be specified, an advertisement that is appropriate to the user may be provided.

(9) The place information specification unit 330 acquires inference information from which place information can be inferred from the user terminal 10, and specifies the place information on the basis of the inference information. Therefore, even if place information cannot be directly acquired, the place information may be specified by the use of inference information. Consequently, delivery of advertisements that have no relevance at all to users may be suppressed, and an increase in advertising effectiveness may be expected.

(10) The place information specification unit 330 acquires user terminal identification information identifying the user terminal 10 from the user terminal 10, and specifies the place information on the basis of the acquired user terminal identification information and a previous ride history of the user. Therefore, even if place information cannot be acquired directly, a location at which the user will stop may be inferred and place information may be specified. Consequently, delivery of advertisements that have no relevance at all to users may be suppressed, and an increase in advertising effectiveness may be expected.

(11) The place information specification unit 330 specifies the place information on the basis of user terminal identification information identifying a user terminal 10 that is moving in correspondence with positions of the on-board terminal 20 and a previous ride history of the user. Therefore, even if information identifying the user terminal 10 cannot be obtained from the on-board terminal 20, the on-board terminal 20 and the user terminal 10 may be associated. Consequently, delivery of advertisements that have no relevance at all to users may be suppressed, and an increase in advertising effectiveness may be expected.

(12) The place information specification unit 330 specifies the place information on the basis of voice information transmitted from the on-board terminal 20 that includes a voice message by a user, a driver or another occupant aboard the mobile body 100. Therefore, even if information identifying the user terminal 10 cannot be obtained, a location at which the user will stop may be predicted and appropriate advertising may be delivered.

A preferred embodiment of the information processing device and program of the present invention is described hereabove. However, the present invention is not limited by the above embodiment and may be suitably modified.

For example, in the embodiment described above, the information processing device 30 is recited as being a single server. However, the information processing device 30 is not limited to being a single server but may be constituted by plural servers.

The embodiment described above depicts an example in which the on-board terminal 20 acquires user terminal identification information and place information from the user terminal 10 when a dispatch app into which a transfer point or destination is entered is used, but this is not limiting. For example, the user terminal identification information and place information representing a destination may be transmitted to a server (not shown in the drawings) of an enterprise administering the mobile body when a dispatch is implemented by the dispatch app. In this case, the server of the enterprise administering the mobile body 100 may transmit the user terminal identification information and the place information to the on-board terminal 20 of the dispatched mobile body 100, and the on-board terminal 20 may transmit the on-board terminal identification information, user terminal identification information and place information to the information processing device 30. If the server of the enterprise administering the mobile body does not provide this function, the information processing device 30 may execute the processing for state 2 described above.

In the embodiment described above, the place information specification unit 330 specifies place information from a previous ride history of the user only after the terminal association unit 320 has made a determination as to whether it is possible to access information within the user terminal 10, but this is not limiting. That is, the terminal association unit 320 may access information within the user terminal 10 and acquire inference information only when place information cannot be specified from the previous ride history of the user.

In the embodiment described above, if plural transfer points/destinations are candidates for the place information, priorities for specifying the candidates as the place information may be arbitrarily determined. For example, when the place information specification unit 330 specifies place information from the previous ride history of the user, the place information specification unit 330 may apply priorities to the transfer points/destinations and specify the place information on the basis of times of day of riding, frequencies of occurrence, recency in the ride history or the like,

Further, the terminal association unit 320 may acquire more recent inference information with greater priority.

In the embodiment described above, the imaging unit 23 (for example, a camera) provided at the on-board terminal 20 may be used to image the face of a user, and the terminal association unit 320 may acquire an image containing the face of the user from the on-board terminal 20 to be used as a captured image. On the basis of the face of the user contained in the captured image, the advertisement delivery unit 36 may infer the sex, age and the like of the user, and specify and acquire advertisement information to be delivered. In this case, in addition to areas, the advertisement information database stores advertisement files that are associated with ages, sexes and the like as the advertisement information. If two or more users are riding in the mobile body 100 and two or more sets of user terminal identification information are acquired, the terminal association unit 320 may infer the sexes, ages and the like of the users from the captured image and deliver advertisement information for a user who is located facing the on-board terminal 20.

In the embodiment described above, the area specification unit 34 specifies an area containing a place represented by place information, but this is not limiting. For example, the area specification unit 34 and area information database 33 need not be provided; instead, the place information acquisition unit 32 may transmit the place information directly to the advertisement delivery unit 36. The advertisement delivery unit 36 may acquire advertisement information to be delivered from the advertisement information database 35 on the basis of this place information, and deliver the acquired advertisement information to the on-board terminal 20.

In the embodiment described above, if place information cannot be specified by analyzing voice messages, the place information specification unit 330 specifies that there is no place information, but this is not limiting. In this situation, the place information specification unit 330 may, for example, infer a transfer point or destination and specify place information from a progress direction of the mobile body, time of day and the like (inferring a location statistically designated by most users as a transfer point or destination for that time of day and progress direction), or from information acquired by the camera of the on-board terminal (if facial images of users are registered as history information, using degrees of matching between a facial image contained in an image acquired by the camera and the registered facial images), or the like.

If place information cannot be specified even in these cases, the place information specification unit 330 may specify a destination registered in a driver's terminal such as a car navigation system, a transfer point or destination selected in a selectable display of transfer points and destinations at the on-board terminal, a transfer point or destination entered directly into the on-board terminal, or the like as the place information.

In the embodiment described above, if a user riding in the mobile body sets a location at which another user is present as a transfer point or destination, the place information specification unit 330 may specify a location represented by position information of the another user as the place information. If the position information of the another user is collected by, for example, a server (not shown in the drawings) of an enterprise that provides another application (for example, a map guidance application), this position information may be acquired from the server of that enterprise subject to permission having been granted by the another user. Alternatively, information for communicating with a communications terminal carried by the another user (for example, address information in an application for communications) may be acquired from the user terminal 10, and the position information of the another user may be acquired by communicating with the communications terminal carried by the another user.

### EXPLANATION OF REFERENCE NUMERALS

10 User terminal
20 On-board terminal
30 Information processing device
32 Place information acquisition unit
34 Area specification unit
36 Advertisement delivery unit
23 Imaging unit
100 Mobile body
320 Terminal association unit
330 Place information specification unit

1. An information processing device that delivers advertisement information to an on-board terminal employed in a mobile body, the information processing device comprising:
a place information acquisition unit that acquires, as place information, information pertaining to a place that a user aboard the mobile body is approaching, the place information being based on dispatch information used for dispatching the mobile body and historical information of the dispatch information, and the dispatch information and historical information being transmitted from a user terminal carried by the user; and
an advertisement delivery unit that acquires advertisement information on the basis of the acquired place information, and delivers the acquired advertisement information to the on-board terminal.

2. (canceled)

3. The information processing device according to claim 1, wherein the place information acquisition unit includes:
a terminal association unit that associates the user terminal carried by the user aboard the mobile body with the on-board terminal; and
a place information specification unit that specifies the place information on the basis of information pertaining to the user terminal associated with the on-board terminal,
wherein the advertisement delivery unit delivers the advertisement information to the on-board terminal associated with the user terminal, and
the place information specification unit acquires from the user terminal, as inference information from which place information may be inferred, information that is used for a purpose unrelated to the dispatch of the mobile body, and specifies the place information on the basis of the inference information.

4. The information processing device according to claim 3, wherein the terminal association unit associates the user terminal with the on-board terminal on the basis of information acquired from the user terminal by communications between the user terminal and the on-board terminal.

5. (canceled)

6. The information processing device according to claim 3, wherein the terminal association unit acquires position information of the on-board terminal and position information of an arbitrary plurality of user terminals, and associates the on-board terminal with a user terminal that is moving in correspondence with positions of the on-board terminal.

7. (canceled)

8. (canceled)

9. (canceled)

10. (canceled)

11. (canceled)

12. (canceled)

13. A program executable by a computer comprising a processor, which program causes the computer to realize the functions of an information processing device that delivers advertisement information to an on-board terminal employed in a mobile body,
the program causing the computer to function as:
a place information acquisition unit that acquires, as place information, information pertaining to a place that a user aboard the mobile body is approaching, the place information being based on dispatch information used for dispatching the mobile body and historical information of the dispatch information, and the dispatch information and historical information being transmitted from a user terminal carried by the user; and
an advertisement delivery unit that acquires advertisement information on the basis of the acquired place information, and delivers the acquired advertisement information to the on-board terminal.

14. The information processing device according to claim 1, wherein the place information acquisition unit acquires, as the dispatch information, information representing a transfer point or information representing a destination, which information is designated by the user at a time of dispatch of the mobile body.

15. The information processing device according to claim 1, wherein the place information acquisition unit acquires, as the dispatch information, information representing a transfer point or information representing a destination, which information is designated by the user at a time of dispatch of a mobile body other than the mobile body.

16. The information processing device according to claim 1, wherein the place information acquisition unit acquires the dispatch information from equipment of an administrative operator of the mobile body, which equipment receives the dispatch information transmitted from the user terminal.

17. The information processing device according to claim 1, wherein the place information acquisition unit acquires the place information on the basis of position information of another user other than the user aboard the mobile body.

18. The information processing device according to claim 17, wherein the place information acquisition unit acquires the place information on the basis of the position information of the another user when the user aboard the mobile body designates the position of the another user as a transfer point or destination.

19. The information processing device according to claim 1, wherein the advertisement delivery unit infers an attribute of the user aboard the mobile body on the basis of a captured image in which the user is imaged, which image is transmitted from the on-board terminal, and acquires the advertisement information on the basis of both the inferred attribute of the user and the acquired place information.

20. The information processing device according to claim 19, wherein when a plurality of users are aboard the mobile body, the advertisement delivery unit acquires the advertisement information on the basis of both an attribute of a user among the plurality of users who is facing the on-board terminal and the acquired place information.
